(19) United States
(12) Patent Application Publication
(10) Pub. No.: US 2003/0033915 A1
(43) Pub. Date: Feb. 20, 2003

(54) Apparatus and process for cutting sheet-shaped print materials

(76) Inventors: Gerhard Glemser, Stuttgart (DE); Joachim Kranz, Boll (DE); Jurgen Ries, Ostfildern (DE); Karsten Uekert, Boll (DE)

Correspondence Address: Kevin Leffel, Heidelberg Digital L.L.C., 2600 Manitou Road, Rochester, NY, 14624, US

(21) Appl. No.: 10/207,497

(22) Filed: Jul. 29, 2002

(30) Foreign Application Priority Data
Sep. 24, 2001 (DE) 101 46 923.3
Jul. 30, 2001 (DE) 101 37 165.9

(51) Int. Cl. B26D 5/28

(52) U.S. Cl. 83/26; 83/110; 83/371

(57) ABSTRACT

The invention relates to a devices and apparatus for processing of sheet-shaped print materials, for example cutting. An apparatus and process for on-the-fly cutting of sheet-shaped print material is provided wherein sheet-shaped print material is cut with a cutting device, an edge of said sheet-shaped print material is sensed upstream from the cutting device, and cutting of the sheet-shaped print material by the cutting device is initiated dependent upon a length of the sheet-shaped print material and the sensing of an edge.

The invention relates to an apparatus and process for cutting sheet-shaped print materials.

Typically devices of the type named, transverse cutters as they are called, are used in order to cut flat materials, i.e. sheeting that are printed in web-fed printing presses, into sheets. Transverse cutters can be differentiated by characteristics, such as on-the-fly or static cutting, depending on whether the flat material moves or not while it is being cut. In addition, transverse cutters can be classified as rotary or linear cutting devices because of the movement of the cutting elements. Another characteristic results from the type of actuation of the processing procedure whereby devices can be differentiated based on the characteristic that the processing elements are continuously in motion or discontinuously, i.e. each individual processing step begins from standstill. All of these different characteristics have advantages and disadvantages that are known to a person skilled in the art due to an extensive state of the art which is described in detail, e.g. in H. Kipphan: “Handbuch der Printmedien [Print Media Manual]”; Springer Verlag (2002), page 826f.

Among devices with discontinuous processing procedures, the German patent specification DE 34 19 254 C1 discloses a device for on-the-fly perforation using a rotary punching device with a pair of rollers having mating punches and dies, in which the punching process is triggered by a sensor. In this case, the sensor is mounted before the punching device in the path of the sheet-shaped print materials. Upon detection of the leading edge of a sheet, the punching process is triggered either directly or with a set time delay. In this way, the position of the holes in the paper can be determined and also varied.

Frequently, it is advantageous to cut sheets in different formats with one device. U.S. Patent specification U.S. Pat. No. 5,662,018 discloses a rotary cutting device that permits this. To do this, blades are mounted on the circumference of a roller and extend beyond the circumference of the roller. On a second roller that is parallel to the first roller but rotates in the opposite direction, opposing blades to the blades of the first roller are mounted so that upon synchronization of the rollers the blades of the first roller interact with the opposing blades of the second roller in order to cut a flat material passing between the rollers. The blades are spaced along the circumference of the roller, corresponding to the desired format to which a flat material running through the rollers will be cut. Recesses are machined into the circumference of the second roller in such a way that during cutting to a specific format type, only the corresponding blades and opposing blades work together respectively to cut the flat material passing through the rollers. In this case, the other blades drop into corresponding recesses on the circumference of the second roller so that they do not tear the continuous flat material. In order to cut different formats, it is only necessary to change the relative angular position of the two rollers with respect to each other so that a different blade/opposing blade pair work together.

European Patent Application EP 1029640 A2 discloses a transverse processing device that has two processing units that are arranged one after the other and, because of this, represent two successive processing levels, whereby one of the processing units can be selected respectively by a control. In one embodiment, the transverse processing device is made up of a first synchronous cutter and a directly adjacent dynamic variable transverse cutter. According to the disclosure, one of the transverse cutters can be stopped respectively as long as the other one is working. The individual cutter that is stopped in this case forms an opening into which a guide table can be inserted. The option to use two transverse cutters allows for cutting a larger number of different formats.

A device is known from U.S. Pat. No. 5,511,744 in which the print material is supplied on rollers for a copier/digital printer and is cut into sheets before printing.

In many applications, especially copiers and/or digital printing devices that typically have a number of different sheet formats in different supply containers, it would be advantageous if these sheets could be cut without having to set the size of the sheet to be cut each time. This is especially true for sheets cut into smaller formats that cannot be printed in these copiers and/or digital printers, such as sheets of European AS size and smaller.

### SUMMARY OF THE INVENTION

According to one aspect of the invention, an apparatus and process for cutting of sheet-shaped print material is provided. Sheet-shaped print material is cut with a cutting device. An edge of the sheet-shaped print material is sensed upstream from the cutting device. Cutting of the sheet-shaped print material by the cutting device is initiated dependent upon a length of the sheet-shaped print material and sensing an edge.

### BRIEF DESCRIPTION OF THE DRAWINGS

FIG. 1 presents a schematic top view of an embodiment of the device according to the invention.

FIG. 2 presents a schematic side view of an embodiment of the device according to the invention.

### DETAILED DESCRIPTION

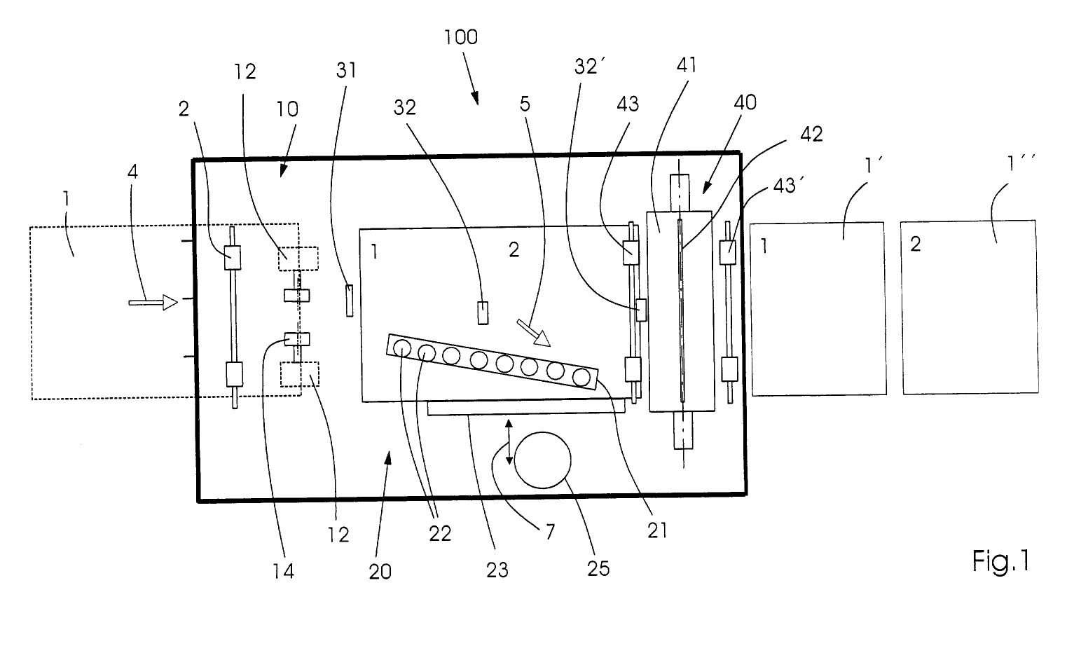

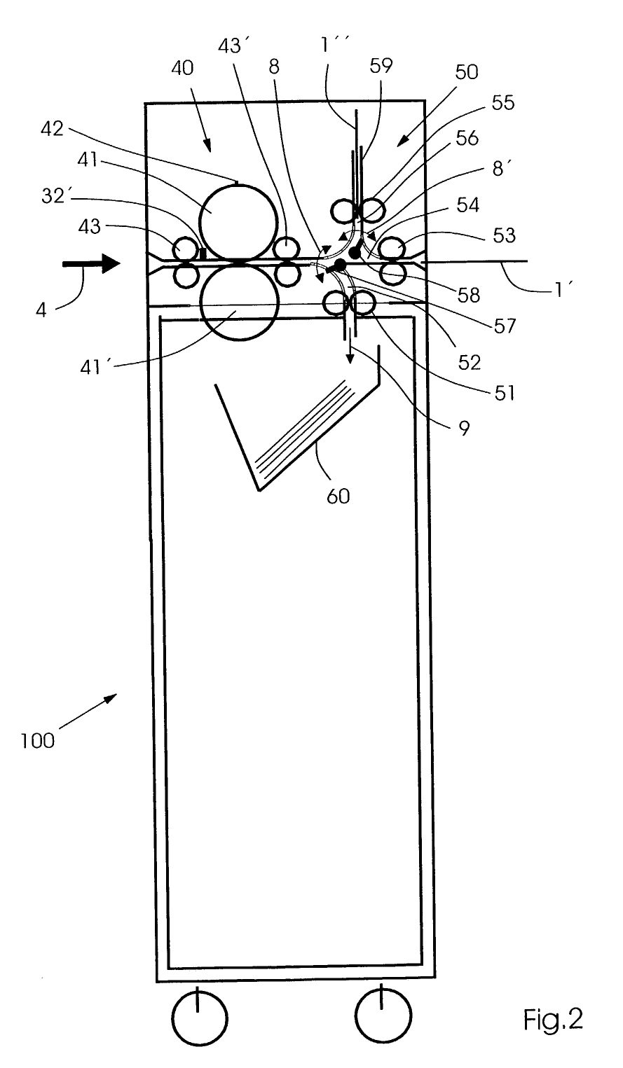

Various aspects of the invention are presented in FIGS. 1 and 2, which are not drawn to any particular scale, wherein like components in the numerous views are numbered alike. Generally known mechanical components, such as drive and/or guide elements implemented in carrying out the invention are shown schematically and/or are described in a general way.

As FIG. 1 shows, a sheet-shaped print material 1 is transported along a transport path indicated with the arrow with reference number 4 through an apparstus 100. A sheet-shaped print material 1 can come from a supply bin that is not shown but is known to the person skilled in the art or from an upstream processing device, for example a printer/copy machine or a collator. The transport rollers 2 receive and transport the sheet-shaped print material 1 within a pre-depository 10. Two individually controllable electric motors 12, which are in active connection with each transport roller 14, correct any misalignment of the sheet-shaped print material 1 and carry out a first rough alignment of sheet-shaped print material 1.

A length sensor 31 is mounted downstream of the pre-depository 10 in order to measure the length of each sheet-shaped print material 1 that passes by and to transfer the data determined to electronics (not shown) which in turn determine the length of sheet-shaped print material 1 based on the signals from length sensor 31. Using the length of sheet-shaped print material 1, the electronics determine the cutting line through sheet-shaped print material 1, especially the position of the center (in transport direction) of sheet-shaped print material 1. In addition, the electronics determine the time delay from the position of the cutting line through sheet-shaped print material 1. This time delay is provided between a sensor signal of a trailing edge sensor 32 or leading edge sensor 32′ and the initiation of the cutting process, in order to ensure that the sheet-shaped print material 1 is cut precisely through the determined cutting line. In doing so, the initiation of the cutting process corresponds to setting the cutting module 40 into motion.

In the area of a depository 20, the sheet-shaped print material 1 is aligned centrally with respect to the transport path of the sheet-shaped print material 1 through the device 100 according to the present invention. With the aid of a diagonally running band that is not shown, but is known to the person skilled in the art, the sheet-shaped print material 1 is guided on a semi-incline along the arrow marked with reference number 5 against a stop 23. In the process, a ball rail 21 bearing balls 22 is used to improve contact between the sheet-shaped print material 1 and the band that runs diagonally. The stop 23 can be moved back and forth along the arrow identified with reference number 7 so that the stop allows for an alignment with respect to the transport path of sheet-shaped print material 1 through the inventive device 100 that is adjusted to the format of the sheet-shaped print material 1. The position of stop 23 is changed automatically in this embodiment with the aid of a cam plate 25 based on a preset format size of the sheet-shaped print material 1.

At the end of the depository 20, the sheet-shaped print material 1 is received by a pair of transport rollers 43, 43′ and transported to the cutting module 40. An edge sensor 32, 32′ is mounted before the cutting module 40. Depending on the embodiment of the device 100 according to the invention, this involves either a trailing edge detector 32 that is mounted far ahead of the cutting module 40, or a leading edge detector 32′ that is located closer to the cutting module 40. The cutting module 40 essentially consists of a tool roller 41 and an opposing roller 41′ that are mounted with their axles parallel to one another and driven so that they rotate synchronously in opposite directions, whereby the tool roller 41 is located above and the opposing roller 41′ is located below the transport path of the sheet-shaped print material 1. The tool roller 41 has a cutting element 42 on its circumference such that the cutting element 42 extends into the transport path and, in combination with the opposing roller 41′, cuts a continuous sheet-shaped print material 1 into a first part 1′ and a second part 1″.

When the apparatus 100 is in a normal state, the tool roller 41 and the opposing roller 41′ rest in a position in which the transport path is not blocked by the cutting module, e.g. with the cutting element 42 on the side turned away from the transport path of the sheet-shaped print material 1. A sensor signal from an edge detector 32, 32′ sets the tool roller 41 and opposing roller 41′ into motion after the time interval determined by the electronics lapses so that the cutting element 42 interacts with the opposing roller 41′ precisely when the sheet-shaped print material 1 is right between the tool roller 41 and the opposing roller 41′, such that the interaction of tool roller 41 and opposing roller 41′ results in cutting the sheet-shaped print material 1 at the intended cutting line. The time interval is calculated from the distance of the edge sensor 32, 32′ to the cutting position and the speed with which the sheet-shaped print material 1 moves on the transport path through the device according to the invention 100.

Downstream of the tool roller 41 and opposing roller 41′, another pair of transport rollers 43′ is mounted that further transports the cut parts 1′, 1″ of the sheet-shaped print material 1. For this purpose, the transport rollers 43′ are driven such that the transport speed can be increased briefly while the first part 1′ is being conveyed. Because of this, the first part 1′ travels a greater distance, thus increasing the distance between the parts 1′, 1″, whereby the successive processing devices can use, for instance, the leading and/or trailing edges of the parts 1′, 1″ as references and the probability of a faultless transport of parts 1′, 1″ of sheet-shaped print material 1 is increased.

FIG. 2 shows another embodiment of the apparatus 100 according to the present invention. In this process, sheet-shaped print materials 1 which are already aligned with respect to the center line of the transport path of the sheet-shaped print material 1 through the inventive device 100 are supplied and received by the pair of transport rollers 43. In contrast to the embodiment described above, a transport path control device 50 is mounted after the cutting module 40.

The transport path control device 50 comprises additional transport paths 52, 54, 56, in which a sheet-shaped print material 1 or parts thereof 1′, 1″ are moved by assigned pairs of transport rollers 51, 53, 55. In the embodiment shown, a first transport path switching element 57 is mounted at the infeed of the transport path control device 50. The transport path switching element can be moved in the direction of the arrow marked with reference number 8, and depending on its position, opens a first transport path 52 or directs the sheet-shaped print material 1 or parts thereof 1′, 1″ to the other transport paths 54, 56. The first transport path 52 conveys the sheet-shaped print material 1 or parts thereof 1′, 1″ along the arrow marked with reference number 9 to a waste container 60.

A second transport path switching element 58 guides the sheet-shaped print material 1 or parts thereof 1′, 1″ along a third transport path 56 to a park position 59 or conveys the sheet-shaped print material 1 or parts thereof 1, 1″ along a second transport path 54 out of the inventive device 100, e.g. to a downstream device (not shown) for further processing or to a tray (not shown) for holding sheet-shaped print material 1 that is known to the person skilled in the art.

A sheet-shaped print material 1 or parts thereof 1, 1″ that is directed to the park position 59 remains in park position 59 until a desired number of additional subsequent sheet-shaped print material 1 have left the inventive device 100 along the first transport path 52 or the second transport path 54 and will then be fed into the second transport path 54 by setting the second transport path switch element 58 by means of the pair of transport rollers 55 which are assigned to the third transport path 56. Because of the nature of second transport path switching element 58, the sheet-shaped print material 1 or parts thereof 1, 1″ located in park position 56 will be turned using a Y-turn which is known based on the state of the art.

An example is provided here to describe the processing of a brochure with sixteen DIN A5 pages with a front and back cover. The pages of the brochure are printed in DIN A4 format by means of an upstream printer/copy machine and sent to the device 100 according to the invention and then aligned, or sent already aligned, whereas the first sheet of DIN A4 print material represents the front and back cover. The first sheet of print material 1 is measured by the length sensor 31, the position of the cutting line is determined by electronics and the time interval is calculated, that is recorded by the edge sensor 32, 32′, between the detection of the trailing or leading edge of the sheet-shaped print material 1 and the time when the cutting process is actuated. After the edge sensor 32, 32′ detects the trailing or leading edge of the sheet-shaped print material 1 and the determined time interval lapses, the cutting module 40 is set in motion and the cutting module 40 divides the DIN A4 sheet-shaped print material 1 into two equally large parts 1′, 1″ of DIN A5 size. The pair of transport rollers 43 that is mounted downstream of the tool roller 41 and opposing roller 41′ accelerates briefly the first part 1′ in order to allow for a gap to develop between the first part 1′ and the second part 1″ and then guide the first part 1′ to the transport path control device 50. The first transport path control element 57 and the second transport path control element 58 are positioned as such that the first part 1′ is guided to the second transport path 54 and after that out of the device according to the invention by means of the pair of transport rollers 53 assigned to the second transport path 54. After the trailing edge of the first part 1′ passes, the second transport path control element 58 swivels into the transport path and guides the second part 1″, namely the back cover, into the park position 59. Then, the second transport path control element 58 swings back and releases the second transport path 54 again, along which the four following DIN A4 sheets, that have now been cut by the cutting module into DIN A5 sheets in the same manner as described, are transported. After the last of the DIN A5 sheets has passed through the device according to the invention by way of the second transport path 54, the second transport path control element 58 releases the second transport path 54 for the back cover 1″ to exit the park position 59. The back cover 1″ is turned by means of the pair of transport rollers 55 assigned to the third transport path 56 and then transported out of the device 100 according to the invention. In this way, the pages of the brochure can be sent in the required sequence to a binding device.

The device described herein, a discontinuously-operating, transverse cutter for sheet-shaped print material, is especially useful for inline further processing of printed products, especially in format reduction of print materials from digital printing machines. The use of the inventive device to cut print materials coming from offset printing machines is also conceivable and lies within the scope of the invention described herein.

According to one aspect of the invention, the cutting process is actuated by electronics in combination with the detection signal of the edge sensor and the length of the sheet-shaped print material to be cut, especially for cutting a sheet-shaped print material in the center.

A length sensor may be installed upstream, before the rotary cutting tool, to determine the length of the sheet-shaped print material in the flow direction. Electronics may be advantageously used to calculate the position of the cut based on the length of the sheet-shaped print material determined by the length sensor mounted before the cutting tool and the time interval after which the cutting process is triggered, as soon as the edge sensor has detected the leading or trailing edge of the sheet-shaped print material. This time interval is calculated from the distance of the edge sensor to the cutting position and the speed with which the sheet-shaped print materials move along the transport path through the device according to the invention. As a result, it is possible to cut optional formats of the sheet-shaped print materials in specific size ratios, particularly into two parts of equal size, without any further manual intervention or any further pre-adjustment with respect to the size of the sheet-shaped print material being processed.

The sheet-shaped print materials may be moved centrally through the rotary cutting tool, independently of their size, on the transport path for the sheet-shaped print materials.

Transport rollers may be provided behind the cutting tool that accelerate the first part of the cut sheet-shaped print material forward so that there is a gap between the first part of the sheet-shaped print material and the second part of the sheet-shaped print material. Because of this, the sheet-shaped print materials are distributed uniformly during the rest of the transport path. This gap allows other sensors to detect the leading edge of each of the cut parts of the sheet-shaped print materials and these can be used, e.g. as a reference for other subsequent machining processes. Moreover, this decreases the probability of incorrect transport of the sheet-shaped print material or the parts.

A transport path control device may be mounted behind the cutting tool so that different transport paths can be set for each of the parts of the cut sheet-shaped print material. This means, for example, additional transport paths can be provided to a waste container or to an intermediate tray to which the cut parts can be selectively guided. Frequently documents that are printed and then bound into brochures have a coversheet consisting of a different material, e.g. a more rigid material. If a coversheet such as this is now cut for a brochure which actually has a smaller format than when printed, two sheets occur as a result of cutting the coversheet. These two sheets now have to be directed to a downstream binding process in succession. With the aid of a transport path control device mounted after the cutting tool, these two sheets can be sorted in a simple way and directed to separate trays or disposed of.

A park position may be provided where one of the parts of the cut sheet-shaped print material is brought and later fed back into the transport path. This may be advantageous, because the cover (front and back) of a sheet-shaped print material may be produced, for instance, using a different material than the rest of the document and thus cut by the cutting device. In such case, the front can be transported after cutting for further processing, while the back is guided to the park position and fed back into the transport path after processing of the entire document such that the correct sequence of pages is ensured for subsequent processing procedures.

A part (a back, for example) may be turned using a Y-turn when that part of the cut sheet-shaped print material is fed back in to the transport path.

A depository may be provided before the cutting tool, by means of which the center line of the sheet-shaped print material is aligned with respect to the center line of the cutting tool.

The apparatus according may be operated in bypass mode during which the sheet-shaped print materials are not cut.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

What is claimed is:

1. An apparatus for cutting of sheet-shaped print material, comprising:
a cutting device configured to cut sheet-shaped print material;
at least one edge sensor mounted upstream from said cutting device; and,
a control, wherein said control initiates cutting by said cutting device dependent upon a length of said sheet-shaped print material and a detection of said sheet-shaped print material by said at least on edge sensor.

2. The apparatus of claim 1, wherein said control initiates cutting by said cutting device in order to divide said sheet-shaped print material equally.

3. The apparatus of claim 1, further comprising a length sensor mounted upstream from said cutting module that determines said length of said sheet-shaped print material.

4. The apparatus of claim 1, wherein said control initiates cutting by said cutting device upon lapse of a time interval from when said edge sensor detects an edge of said sheet-shaped print material.

5. The apparatus of claim 4, wherein said time interval is dependent upon a distance between said edge sensor and a cutting position in said cutting device and a speed of said sheet-shaped print material.

6. The apparatus of claim 1, further comprising a transport path wherein said sheet-shaped print material travels centrally on said transport path irrespective of a size of said sheet-shaped print material.

7. The apparatus of claim 1, further comprising transport rollers downstream from said cutting device, wherein said transport rollers accelerate a first part of a cut sheet-shaped print material relative to a second part of said cut sheet-shaped print material to create a gap therebetween.

8. The apparatus of claim 1, wherein downstream of said cutting device a transport path control device is mounted so that different transport paths can be selected for parts of a cut sheet-shaped print material.

9. The apparatus of claim 1, wherein downstream of said cutting device a transport path control device is mounted that diverts a part of a cut sheet-shaped print material to a park position.

10. The apparatus of claim 9, wherein one part of said cut sheet-shaped print material is fed back from said park position into a different location from whence it came relative to other sheet-shaped print material.

11. The apparatus of claim 8, wherein said transport path control device directs at least one of said parts of said cut sheet-shaped print material to a waste container.

12 The apparatus of claim 1, further comprising a depository upstream of said cutting device, wherein said depository aligns a centerline of said sheet sheet-shaped print material with a centerline of said cutting device.

13. The apparatus of claim 1, wherein said control comprises a bypass mode, in which the sheet-shaped print materials are not cut.

14. A process for cutting of sheet-shaped print material, comprising:
cutting sheet-shaped print material with a cutting device;
sensing an edge of said sheet-shaped print material upstream from said cutting device; and,
initiating cutting of said sheet-shaped print material by said cutting device dependent upon a length of said sheet-shaped print material and said sensing an edge.

15. The process of claim 14, further comprising determining a length of said sheet-shaped print material with a length sensor mounted upstream from said cutting device.

16. The process of claim 14, further comprising initiating cutting by said cutting device upon lapse of a time interval from when said edge sensor detects an edge of said sheet-shaped print material.

17. The process of claim 16, wherein said time interval is dependent upon a distance between said edge sensor and a cutting position in said cutting device and a speed of said sheet-shaped print material.

18. The process of claim 14, further comprising accelerating a first part of a cut sheet-shaped print material relative to a second part of said cut sheet-shaped print material to create a gap therebetween.

19. The process of claim 14, further comprising selecting different transport paths for parts of a cut sheet-shaped print material.

20. A process for cutting of sheet-shaped print material, comprising:
cutting sheet-shaped print material with a cutting device;
sensing an edge of said sheet-shaped print material upstream from said cutting device;
initiating cutting of said sheet-shaped print material by said cutting device dependent upon a length of said sheet-shaped print material and said sensing an edge;
accelerating a first part of a cut sheet-shaped print material relative to a second part of said cut sheet-shaped print material to create a gap therebetween; and,
selecting different transport paths for parts of a cut sheet-shaped print material.
